(19) United States
(12) Patent Application Publication
(10) Pub. No.: US 2006/0262139 A1
(43) Pub. Date: Nov. 23, 2006

(54) Device and method for operating a plurality of medical equipment

(75) Inventor: Norbert Rahn, Forchheim (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 11/435,185

(22) Filed: May 16, 2006

(30) Foreign Application Priority Data
May 17, 2005 (DE) 10 2005 022 538.1

(51) Int. Cl. G09G 5/00

(52) U.S. Cl. 345/629

(57) ABSTRACT

The invention relates to a device and a method for operating a plurality of medical equipment of an examination and treatment unit, which comprises at least two items of medical equipment, where a first data source provides data from the first item of medical equipment and a second data source provides data from the second item of medical equipment, and a common control and processing unit having an input unit and a display device processes data from the at least two data sources, whilst the processing of the data can be controlled via the same input unit, and the display of the processed data can be displayed on the same display device.

This application claims priority to the German Application No. 10 2005 022 538.1, filed May 17, 2005 which is incorporated by reference herein in its entirety.

### FIELD OF INVENTION

The invention relates to a device and a method for operating a plurality of medical equipment, in particular for parallel operation of an X-ray machine and an electro-anatomical 3D mapping machine, and for parallel display of the corresponding examination results.

### BACKGROUND OF INVENTION

In clinical examinations or treatments, there is often the need to use more than one item of medical equipment simultaneously in order to provide the doctor with certain information. Examples of such applications are minimally invasive examinations or treatments using instruments such as end oscopes, laparoscopes or catheters, which are each introduced into the patient via a small body orifice while simultaneously the position of the instrument is determined by an X-ray machine e.g. by means of C-arm rotational angiography, or the position of certain internal organs is identified. Catheters are often used as part of cardiological examinations, for example for heart arrhythmias, which are treated nowadays by what are known as ablation procedures.

### SUMMARY OF INVENTION

Determining in parallel the position and orientation of medical instruments using X-ray diagnostics is also of particular importance in catheter interventions, in particular in the use of imaging catheters for intracardial or intravascular ultrasound imaging, but also in OCT imaging or in applications in which catheters are navigated in three-dimensional image data.

The exact determination of the position and orientation of a medical instrument is performed in the state of the art, for example, using electromagnetic navigation systems (for example the CARTO®-System from the Biosense Webster company, Calif., USA). In these systems, sensors for detecting changes in the electromagnetic field are integrated in the medical instrument, whilst an electromagnetic field is created around the patient. By this means it is possible to determine the three degrees of freedom of position (X, Y and Z coordinates) and the three degrees of freedom of orientation (pitch, yaw an d roll data).

Using an X-ray machine (for example the AXIOM ARTIS dFC®-System from the Siemens company, Medical Solutions, Erlangen, Germany), X-ray images can be taken simultaneously of an area of interest of the patient.

In the customary examination of a patient, the two-dimensional X-ray images from the X-ray system are displayed in a “monitor bank” permanently assigned to the X-ray system, whilst the visualization of an electro-anatomical 3D mapping system is currently displayed on a separate monitor. The electro-anatomical 3D mapping system can be used to determine the position and orientation of a medical instrument, or even to create a three-dimensional surface model of an organ that is being simultaneously X-rayed, for example, by means of X-ray images recorded in parallel.

The input devices of the medical equipment exist separately and are designed separately in the state of the art. The doctor, for example, must use controls (e.g. joystick, button panels, pedals, etc.) mounted on the patient couch to control specific functions of the X-ray system while X-ray images are simultaneously being taken of the area in which the catheter tip is located in the intervention. In this situation, the design of the input devices of the X-ray system and the electro-anatomical 3D mapping system is duplicated. The individual controls (e.g. pedals, joysticks, trackballs etc.) of the X-ray system and the 3D mapping system or additional medical examination equipment need to be operated in parallel.

Furthermore, the individual systems differ in terms of their operating strategies. Thus the clinical user, while simultaneously operating different medical equipment, must allow for different operating philosophies, possibly resulting in operational mistakes, which are particularly undesirable for medical applications.

Finally, the separate arrangement of display devices forces the doctor to look back and forth between each different display, which again can result in mistakes.

Hence an object of the present invention is to define an improved device and a method suited to it for operating a plurality of medical equipment, in which the aforementioned disadvantages are avoided and the number of mistakes is reduced.

This object is achieved by the claims.

The device according to the invention for operating a plurality of medical equipment comprises an examination and treatment unit, which contains at least two items of medical equipment for examining or treating a patient. A first data source provides data from the first item of medical equipment and a second data source provides data from the second item of medical equipment. According to the present invention, the data from both data sources is processed by a control and processing unit, where the processing of the data can be controlled via the same input unit, and the display of the processed data can be displayed on the same display device. By integrating a plurality of input units in an “operating console”, the medical user can operate simultaneously, i.e. in parallel, a plurality of medical equipment using the same input devices. This also allows the input devices, such as mouse, joystick, trackball or keyboard, to be harmonized such that identical or similar actions are performed on different medical equipment when the user operates the same input devices in an identical or similar way.

According to a first advantageous embodiment of the invention, the control and processing unit comprises a first data processing unit for processing the data from the first data source, and a second data processing unit for processing the data from the second data source, so that the data from the two data processing units can be sent to the display device via a switch or via two parallel transmission paths or by means of a pre-definable encoding. For this purpose, the input unit advantageously has a selector switch or an encoding unit for selecting or respectively encoding the data entered, or the input commands for the input of parameters and control commands for the control and processing unit. Depending on the type of the data or input commands, different medical equipment and/or different data processing units inside the control and processing unit and/or different display modalities can then be accessed or selected.

If the doctor moves the joystick forwards, for example, then according to a first input modality, the C-arm of an X-ray machine can be rotated, for example, and in a second input modality, the ultrasound head in a catheter tip can be rotated, depending on which input modality (X-ray or ultrasound) the doctor has selected, for instance by pressing a button on the top end of the joystick.

The display device is, for example, a monitor bank of an X-ray machine containing six monitors. One or two monitors of the display device can then be used to display data from an electro-anatomical 3D mapping system or from a multi-modality visualization system.

According to a further advantageous embodiment of the present invention, the input unit comprises input sub-devices for an X-ray machine, such as joystick, control screen, mouse, keyboard, trackball or pedal, where each of the input sub-devices individually, or all of the input sub-devices jointly, can be assigned by means of a selector switch or encoding to individual input commands for controlling individual items of medical equipment or output commands for displaying the processed data. This can be done, for example, via an input sub-device on the input unit for entering data and selecting fields, where the data can be used for configuration and the fields for selecting the functions of the medical equipment or selecting the items of equipment themselves and/or the setting conditions of the monitors of the display device.

Additional data, such as the patient's master data, pre-operative image data of the patient's organs, archive data or data from other equipment such as E CG machines, can advantageously be entered in the control and processing unit via the input unit and stored there, where this data can then be made available to all the items of medical equipment, which can be accessed at the control and processing unit vi a the input unit.

The invention also relates to a method for operating a plurality of medical equipment of an examination and treatment unit, which comprises at least two items of medical equipment, where a first data source is provided with data from the first item of medical equipment, a second data source is provided with data from the second item of medical equipment, and a control and processing unit is supplied with data and commands from an input unit and outputs data to a display device, where the data from the at least two data sources is processed in the control and processing unit, and where the processing of the data is controlled via the same input unit, and the display of the processed data is shown on the same display device.

The data from the two data sources is advantageously processed in two separate data processing units in the control and processing unit, so that the data from these two data processing units can then be sent after processing to the display device via a switch or via two parallel transmission paths or by means of a pre-definable encoding. Depending on the type of the input commands, different medical equipment or different data processing units or different display modalities can be accessed.

### BRIEF DESCRIPTION OF THE DRAWING

The FIGURE depicts an exemplary embodiment of a system for operating a plurality of medical devices of an examination and treatment facility.

### DETAILED DESCRIPTION OF INVENTION

The device according to the invention and the method according to the invention are particularly suitable for integrating the user interface (input unit) of an electro-anatomical 3D mapping system in the user interface of an X-ray machine. For this purpose, the invention provides in particular four key integration steps, which are explained in more detail below with reference to the enclosed drawing, in which:

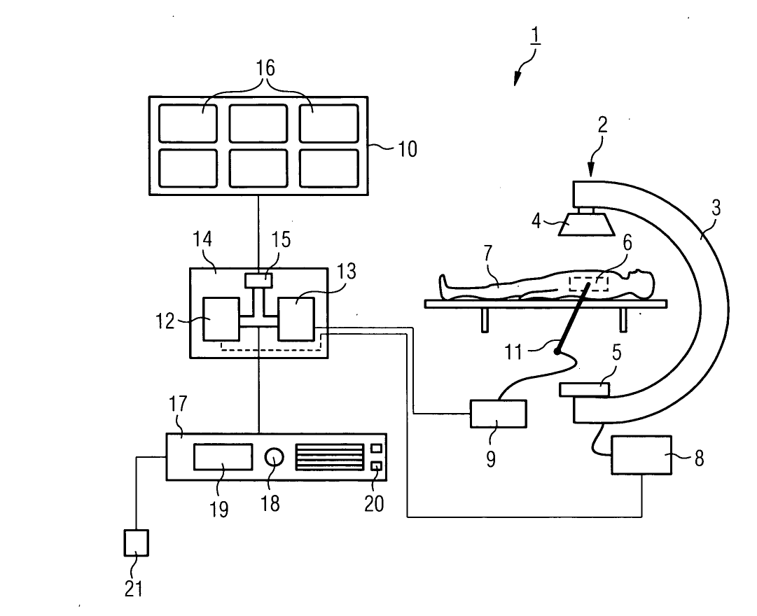

FIG. 1 shows the schematic diagram of a device according to the invention having an examination/treatment unit 1, which comprises an imaging unit 2 having two items of medical equipment 3 and 11, namely a C-arm X-ray machine and a catheter fitted with an ultrasound probe. The catheter is inserted into the examination area 6 of a subject 7, for example via an artery into the immediate area of a heart under examination, and there records individual two-dimensional images of the heart using a rotating ultrasound probe in order to collect data for a three-dimensional reconstruction image.

The item of medical equipment 11 shown in FIG. 1, however, may also be an electro-anatomical 3D mapping machine, which is used in electro-physiology. A catheter having integral position/orientation sensor is moved along the inner surface of the heart chambers of a patient, for example, so that the position and orientation of the catheter can be recorded simultaneously with sensing of the ECG voltage.

The position and orientation of the catheter can be detected, for example, by means of an electromagnetic field, which, for example, is generated by three transmitter coils located around the patient and is detected by suitable receiver coils in the catheter. By recording the changes in the magnetic field in three dimensions, the exact position and the orientation of the catheter tip can be detected. The electrogram data can then be color-coded and displayed on an anatomical 3D image of the examination area. A three-dimensional color image of the electrical activation of the atrium of a heart can then be obtained for example.

The X-ray machine is simultaneously X-raying the examination area 6 using an X-ray source 4, which causes X-rays to be received at a beam detector 5, which supplies data to the first data source 8. The instrument 11 (ultrasound catheter for example) supplies data to the second data source 9. Both data sources 8 and 9 are connected to a control and processing unit 14, which according to a first advantageous embodiment of the invention comprises a first data processing unit 12 and a second data processing unit 13, which receive the data from the two data sources 8 and 9. According to one embodiment of the present invention, both the data processing units 12 and 13 are connected by a switch 15 to a display device 10 comprising a number of monitors 16.

At the same time, the control and processing unit 14 is connected to an input unit 17, which comprises, for example, a joystick 18, a control screen 19, a mouse 20 and a pedal 21. The control screen 19 may be a “touch screen” for example, which, according to the selectable screen display, displays different fields, which when touched send different control commands or data to the control and processing unit 14.

First Integration Level:

In a first integration level, a monitor 16 of the display device 10, for example a monitor bank of the X-ray machine, is used simultaneously for displaying data from an electro-anatomical 3D mapping system. Just one connection is required for this, e.g. from the graphics card of the second data processing unit 13 to one of the monitors 16 of the X-ray machine monitor bank. If required, the monitor 16 can also be used for other medical equipment, for example for visualizing the data from a multi-modality visualization workstation. It is also possible, however, to select between the display modalities by means of a selector switch 15 in the video signal from the respective data processing units 12 and 13, or by encoding of the video signals in a way that suits the data processing unit 12, 13, whereby different monitors 16 of the display device 10 can be addressed. A change in the configuration or to the software of the electro-anatomical 3D mapping system is not necessary for this integration step.

Second Integration Level

In a second integration level, the various input sub-devices of the X-ray machine can be used in parallel to control a 3D mapping system for example. By implementing a selector switch, the input sub-devices can be used in parallel and control accordingly both the X-ray machine and the 3D mapping system. Alternatively, individual input sub-devices can also be assigned exclusively to specific medical equipment in order to avoid “over-functionality”, which could lead to over-complexity.

Third Integration Level

In a further integration level, the present invention can be applied when the input unit is also assigned a standard operating strategy. All the items of medical equipment are addressed using a standard operator software, for example by means of “tabs” on the control screen 19, which may be designed as a “touch screen”. Data used for configuring each item of medical equipment can then also be entered via this control screen 19.

For example, the base functions of an electro-anatomical mapping system can be selected and/or configured using the menus/sub-menus and command buttons of the user interface of the X-ray machine. The input commands at the input unit 17 can be fed to the data processing unit 13 of the electro-anatomical 3D mapping system via a hardware interface, where the following functions of the electro-anatomical 3D mapping system can be selected and/or configured for example:

1. System setup
Calibration
   Coordinate calibration (transmitter)
   Assistance in placing the reference electrode

2. Patient/Studies/File management
Patient registration
Backup/Restore

3. Selection of acquisition or review mode

4. Acquisition of map/surface points
Enabling the pedal
Accepting/rejecting a recorded surface point
Point-list handling of a recorded map
Point selection of the pre-recorded map

5. Map displays
Changing the zoom and orientation
Annotations
Various map types
   Local Activation Time maps
   Voltage maps
   Propagation maps
   Surface maps
   Grid maps
Clipping Planes in maps

6. Map handling
Remap (use of existing geometry for new mapping)

Fourth and Higher Integration Levels

In a fourth integration level it is intended to use the input unit 17 additionally for the input of extra data. If the items of medical equipment are addressed via the same input unit 17, and if the input unit 17 is subject to a standard logical operating strategy, then, for example, patient data (demographic data such as patient ID, name, date of birth, etc.) of the current electro-physiological procedure can be transferred to the respective item of medical equipment, the data being transferred using the common input unit 17.

The electro-anatomical image data can also be transferred via the common input unit 17 together with the X-ray images to a “reporting server” for generating reports on the implementation and result of the electro-physiological procedure.

The standard input unit is also suitable for initiating additional functions, for example for automatic calibration of the X-ray machine and the electro-anatomical 3D mapping system, or automatic transformation of the coordinate systems for recording two-dimensional or three-dimensional image data.

Finally, some of the X-ray machines available today have common interfaces to “recording systems” or to other medical systems, so that, for example, integrating the user interface of an electromagnetic 3D mapping system in the user interface of the X-ray machine would also integrate the 3D mapping system in the other systems.

1.-12. (canceled)

13. A system for operating a plurality of medical devices of an examination and treatment facility, the examination and treatment facility having at least first and second medical devices, the system comprising:
a first data source connected to the first medical device and configured to provide data related to the first medical device;
a second data source connected to the second medical device and configured to provide data related to the second medical device; and
a control and processing unit having an input unit and a display device and configured to:
process the data provided by the first and second data sources;
control the processing of the data provided by both the first and second data sources using the input unit such that the input unit is a common input unit used for controlling the processing of the data provided by both the first and second data sources; and
display the processed data on the display device.

14. The system as claimed in claim 13, wherein the control and processing unit comprises:
a first data processing module for processing the data provided by the first data source; and
a second data processing module for processing the data provided by the second data source, and wherein the data processed by the first and second data processing modules are transmitted to the display device via a switch, via two parallel transmission paths or via a selectable encoding mechanism.

15. The system as claimed in claim 14, wherein the input unit comprises a selector switch or an encoding unit for selecting respectively encoding input commands such that depending on different types of the input commands different medical devices, different data processing modules or different display devices are accessed.

16. The system as claimed in claim 13, wherein
the display device is a monitor system having a plurality of monitors of an X-ray device, and
at least one monitor of the monitor system is used for displaying data originating from an electro-anatomical 3D mapping system or from a multi-modality visualization system.

17. The system as claimed in claim 13, wherein the input unit comprises a plurality of input sub-devices for controlling an X-ray machine, each of the input sub-devices individually or all of the input sub-devices jointly configured to be assigned to individual input commands for controlling individual medical devices.

18. The system as claimed in claim 13, wherein the input unit comprises a plurality of input sub-devices for controlling an X-ray machine, each of the input sub-devices individually or all of the input sub-devices jointly configured to be assigned to individual output commands for displaying the processed data.

19. The system as claimed in claim 13, wherein the input unit has an input sub-unit for entering input data and for selecting fields, the input data used for configuring the medical devices, and the selected fields used for accessing functions of the medical devices.

20. The system as claimed in one of the preceding claims, wherein additional data entered into and stored in the control and processing unit is accessible by the plurality of medical devices.

21. The system as claimed in claim 13, wherein the first medical device is a beam detector of an X-ray source, and the second medical device is an electro-anatomical 3D mapping system.

22. The device as claimed in claim 21, wherein the electro-anatomical 3D mapping system feeds position or orientation data to the control and processing unit, the position respectively orientation data determined by detecting an electromagnetic field, the electromagnetic field detected by receiver coils arranged in a catheter of the electro-anatomical 3D mapping system.

23. A method of operating a plurality of medical devices of an examination and treatment facility, the examination and treatment facility having at least first and second medical devices, the method comprising:
providing a first data source connected to and having data originating from the first medical device;
providing a second data source connected to and having data originating from the second medical device;
providing a control and processing unit for processing data provided by the first and second data sources;
inputting input commands into an input unit of the control and processing unit, the input unit configured to control processing of data provided by both the first and second data sources; and
outputting output commands to a display device, by the control and processing unit, wherein
the control and processing unit is a common control and processing unit for processing data provided by both the first and second data sources,
the input unit is a common input unit for controlling the processing of the data provided by both the first and second data sources, and
the display device is a common display device for displaying processed data related to both the first and second data source.

24. The method as claimed in claim 23, wherein
the common control and processing unit processes the data originating from the first and second data sources via first and second data processing modules, and
data processed by the first and second data processing modules are sent to the common display device via a switch, via two parallel transmission paths or via a selectable encoding mechanism.

25. The method as claimed in claim 23, wherein the input unit has a selector switch or an encoding unit for selecting respectively encoding input commands such that depending on different types of the input commands different medical devices, different data processing modules or different display devices are accessed.
